(19) United States
(12) Patent Application Publication
(10) Pub. No.: US 2021/0221536 A1
(43) Pub. Date: Jul. 22, 2021

(54) DRONE ASSEMBLY HANGER

(71) Applicant: Volansi, Inc., San Francisco, CA (US)

(72) Inventor: Hoang Minh Chung, Jurong (SG)

(21) Appl. No.: 16/952,043

(22) Filed: Nov. 18, 2020

Related U.S. Application Data
(60) Provisional application No. 62/938,811, filed on Nov. 21, 2019.

(51) Int. Cl. B64F 5/10; B64C 39/02

(52) U.S. Cl. CPC B64F 5/10; B64C 2201/021; B64C 39/024

(57) ABSTRACT

Systems, devices, and methods are provided for assembling a drone. A drone assembly system can include a vehicle, a boom configured with a mounting hole located at a top surface of the boom, a wing having a first side, the first side of the wing having a sleeve, and a first hanger having a tube, handle, and tip, configured to be inserted into the sleeve of the first side of the wing and mounted to the mounting hole of the boom in a first position. A hanger is also described and can include a tube, a handle having a cap member and a tubular member operably connected to a first side of the tube with the tubular member, and a tip having a threaded member and locking member operably connected to a second side of the tube with the locking member of the tip.

### CROSS-REFERENCE TO RELATED APPLICATIONS

This application claims the benefit of U.S. Provisional Application No. 62/938,811, filed Nov. 21, 2019, which is hereby incorporated by reference in its entirety.

### BACKGROUND

An unmanned vehicle is a vehicle capable of travel without a physically present human operator. An unmanned vehicle may operate in a remote-control mode, in an autonomous mode, or in a partially autonomous mode. Unmanned aerial vehicles (“UAVs”), such as drones, are used in a wide variety of applications. For example, drones may be used to transport material or goods from one location to another.

Drone aircraft are typically one of two types. A first type is a fixed-wing design, where lift is provided by one or more fixed wings and forward thrust is provided by a spinning propeller, ducted fan, or jet engine. A second type is a helicopter-type design where lift and forward thrust are provided by one or more vertically oriented rotors or rotary wings. Included in this second type is the so-called ‘quad-copter’ design which incorporates four vertical rotors. Manipulation of the relative thrust provided by each of the four rotors provides for variable vertical thrust and forward and lateral movement. Fixed-wing aircraft of the first type are generally efficient in long distance transportation. The various multi-copter designs of the second type are generally less efficient but have the unique ability to take off vertically. These aircraft designs are said to be capable of Vertical Take-Off and Landing, or VTOL.

Drone aircraft that are capable of both long-distance travel and VTOL can greatly benefit modern drone capabilities. Improvements in designing and assembling such drones can also benefit the effectiveness and efficiency of modern drone systems.

### BRIEF SUMMARY

The present disclosure relates generally to systems and methods for a hanger apparatus for assembling an aircraft. In one aspect, a hanger apparatus can include a boom assembly having a vehicle, a boom configured with a mounting hole located at a top surface of the boom, a wing having a first side, the first side of the wing having a sleeve, and a first hanger having a tube, handle, and tip, configured to be inserted into the sleeve of the first side of the wing and mounted to the mounting hole of the boom in a first position. In one aspect, the handle of the hanger is configured to rest on top of a portion of the sleeve and the tip is configured to fasten onto mounting hole of the boom at the first position. In one aspect, at the first position, the boom is suspended beneath the first side of the wing leaving a sufficient gap or distance between an underside of the first side of the wing and the top surface of the boom. In one aspect, the first hanger can be in a second position wherein an underside of the first side of the wing is mounted onto the top surface of the boom. In one aspect, the boom assembly can include a mounting fastener configured to securely mount the first side of the wing to the boom, the mounting fastener mounting the first side of the wing to the boom through the sleeve of the first side of the wing. In one aspect, the vehicle can be an aircraft. In one aspect, the aircraft can be an unmanned aircraft. In one aspect, the sleeve of the first side of the wing runs from a top surface of the wing to a bottom surface of the wing. In one aspect, the wing has a first and second edge having a first and second sleeve, respectively, wherein the second sleeve is configured to receive a second hanger. In one aspect, the wing can include a leading edge having a first sleeve near the leading edge of the first side of the wing and can include a trailing edge having a second sleeve near the trailing edge of the first side of the wing, wherein the first sleeve is configured to receive the first hanger and the second sleeve is configured to receive a second hanger. In one aspect, the first hanger and second hanger have different lengths. In one aspect, a diameter of a first portion of the sleeve can be smaller than that of the diameter of a second portion of the sleeve such that the handle of the first hanger rests on top of the first portion of the sleeve.

According to one aspect, a hanger apparatus can include a tube, a handle having a cap member and a tubular member operably connected to a first side of the tube with the tubular member, and a tip having a threaded member and locking member operably connected to a second side of the tube with the locking member of the tip. The tube can include a hollow elongated rod. The tube can include carbon fiber. The handle can include aluminum. The thread can include hardened steel. And the tubular member of the handle can be a hollow tubular member with a thickness such that an inner diameter of the hollow tubular member is the same diameter as that of an outer diameter of the tube.

Other embodiments are directed to systems and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

Illustrative embodiments are described with reference to the following figures.

FIGS. 1A-1B illustrate a hanger assembly in accordance with various aspects of the subject technology.

FIGS. 2A-2B illustrate a hanger assembly system in accordance with various aspects of the subject technology.

FIGS. 3A-3F illustrate multiple configurations of a hanger assembly system in accordance with various aspects of the subject technology.

FIGS. 4A-4B illustrate a vehicle in accordance with various aspects of the subject technology.

FIG. 5 illustrate a flow diagram of an example method in accordance with various aspects of the subject technology.

### DETAILED DESCRIPTION

In this specification, reference is made in detail to specific embodiments of the invention. Some of the embodiments or their aspects are illustrated in the figures. For clarity in explanation, the system has been described with reference to specific embodiments, however it should be understood that the system is not limited to the described embodiments. On the contrary, the system covers alternatives, modifications, and equivalents as may be included within its scope as defined by any patent claims. The following embodiments of the system are set forth without any loss of generality to, and without imposing limitations on, the claimed method. In the following description, specific details are set forth in order to provide a thorough understanding of the present method. The present method may be practiced without some or all of these specific details. In addition, well known features may not have been described in detail to avoid unnecessarily obscuring the system.

In addition, it should be understood that steps of the exemplary system and method set forth in this patent can be performed in different orders than the order presented in this specification. Furthermore, some steps of the exemplary system and method may be performed in parallel rather than being performed sequentially.

A drone assembly apparatus for better assembling an aircraft is described below. For example, a hanger apparatus configured to assist the assembly of a drone capable of long-distance travel and VTOL is discussed below.

An aircraft capable of long-distance travel and VTOL propulsion will typically include a fixed wing that spans along a fuselage or body of the aircraft and one or more boom assemblies configured with vertically mounted take off propellers. For example, a aircraft, such as a drone, unmanned aircraft, or unmanned aerial aircraft can include a wing and one or more booms. The wing can span across a fuselage of the drone and a pair of booms can be attached to the each side of two sides of the wing such that one boom is on one side of the fuselage and another boom is on another side of the fuselage, connected to the fuselage through the wing. In this example, the vertical takeoff propellers can be mounted onto the pair of booms.

In one example application, the aircraft described above can be light weight and having modular components. For example, an assembled drone can include various modular components such as a fuselage or body, a wing, one or more booms, propellers, rotors, engines, battery, computer hardware, cables and wiring, sensors, etc. In one example, an assembled drone can receive multiple configurations of components that are all designed to fit the drone assembly. For example, an aircraft manufacturing organization can manufacture different designs of a wing or mass manufacture the same design wing, or both, and each wing manufacture can be fitted onto the aircraft. The ability for modular components used for assembling a drone and the ability to swap out one component, with another can greatly increase the productivity, quality, efficiency, time, labor, of operating and storing an aircraft or fleet of aircraft for commercial purposes.

In such a case, the difference between being able to assemble a modular drone from hours to minutes or from multiple human operators to a single human operator for the whole assembly or portions of the assembly can drastically affect the effectiveness of aircraft fleet operation. For example, a two-person job of assembling an aircraft being cut down to one person in a similar range of time required with the same resulting aircraft assembly. Or a portion of assembling a drone that typically takes in the magnitude of tens of minutes or hours to just minutes. Having these improvements, when applied to a fleet of hundreds or thousands of aircrafts each having swappable components or parts can greatly improve a fleet's operations.

In one example, aircraft described above, such as a small unmanned aerial vehicle (“sUAV”), during the assembly process of a given aircraft in a fleet will require a step of assembling a wing to a vehicle, and assembling one or more booms configured with vertical propellers to the wing. Typically, during this process, both the booms and wing needs to be physically attached to each other securely such that during flight or if expected forces are applied to each of the booms or wing, the boom and wing will not disconnect. Additionally, electrical cables, wiring, and electrical components are installed and connected between the boom and the wing or between the boom and any other component of the aircraft. This step is usually done before fully mounting and sealing the one component with another so that electrical components or wires are not exposed on the outside during flight so that electrical components and wires are protected by the body of each component.

For example, when installing a boom to a wing, the electrical components and wiring that may be used to control and regulate the propellers of the boom will need to be connected to a central computer or other electoral components of the aircraft. This can be done by electrical connectors coming out of the wing, at a location near the point of physical contact between the body of the boom and one surface of the wing. For example, a bottom surface of the wing can be configured to receive a top surface of a boom such that when in contact, the bottom surface of the wing and top surface of the boom can be secured to each other with mounting fasteners or latches or other securing mechanisms. Before the wing and boom is fully secured and the aircraft is in flight, a technician or operator will need to connect any electrical components between the boom and the wing. In this example, the connecting wires that bridge the electronical connection between electrical components of the boom and electrical components of the wing or body of the vehicle can be connected near the top surface of the boom and the bottom surface of the wing. For example, an opening at the top surface of the boom and an opening at the bottom surface of the wing can be configured to allow electrical wires to pass through and connect with each other. Because the openings of each of the booms and wing would leave the electrical components and wiring exposed to the outside environment, the booms and wings and openings are designed such that when the boom and wing are secured to each other, the openings are sealed.

Typically, two or more operators would be required to connect one or more boom to the wing. One operator would hold the boom underneath the wing such that sufficient space is present between the boom and the wing for the other operator to physically connect any and all wires and electrical components required to connect the electrical components of the boom to the rest of the vehicle, including the battery and controller. In another instance, one operator can perform the task but would need to first securely lift the boom underneath the wing. This can be accomplished by placing the boom on a platform such that when resting on the platform, the boom is underneath the wing with sufficient space for the operator to work and connect electrical components to each other.

This method of assembling an aerial vehicle can be both inefficient, slow, and require large equipment or take up unnecessary space. An apparatus designed to allow quick assembly of the aircraft with only a single operator with a fast yield is described below.

While the examples discussed above and further examples discussed below describe assembling an example boom with an example wing of an unmanned aerial aircraft, the hanger apparatus can be applied to any system design where at least two physical components of a system are to be physically secured to each other and require a step of connecting sensitive and fragile components, such as electrical wiring, moments before securing the two components together. For example, a boom can be assembled directly to a fuselage of a vehicle. In another example, a wing can be assembled to the fuselage of the vehicle such that either the wing or fuselage needs to be suspended beneath the other component with a sufficient gap to perform electrical work before ultimately securing the two components together. The apparatus can be utilized in applications beyond aerial aircraft technology and can be applied to any system where modular components are used and quick assembly for a fleet of modular systems are desired.

A. Drone Assembly System

An aircraft assembly system for effectively and efficiently assembling a component of an aircraft onto another component of the aircraft is described below.

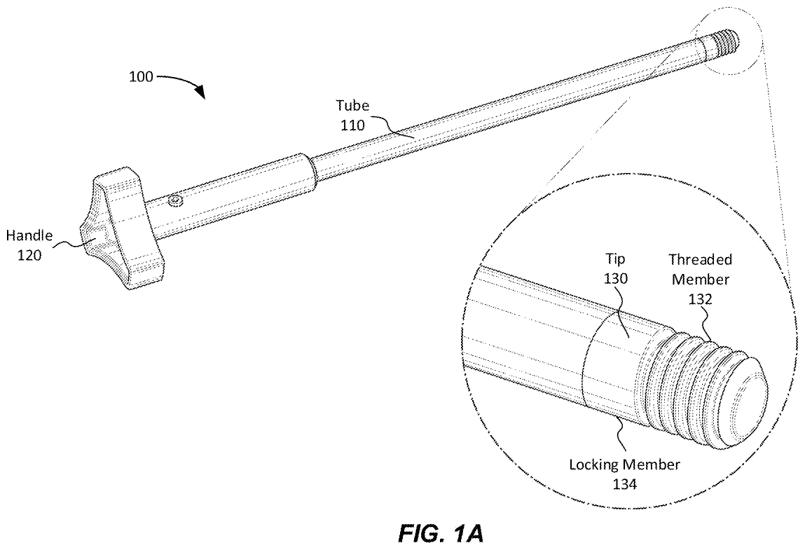

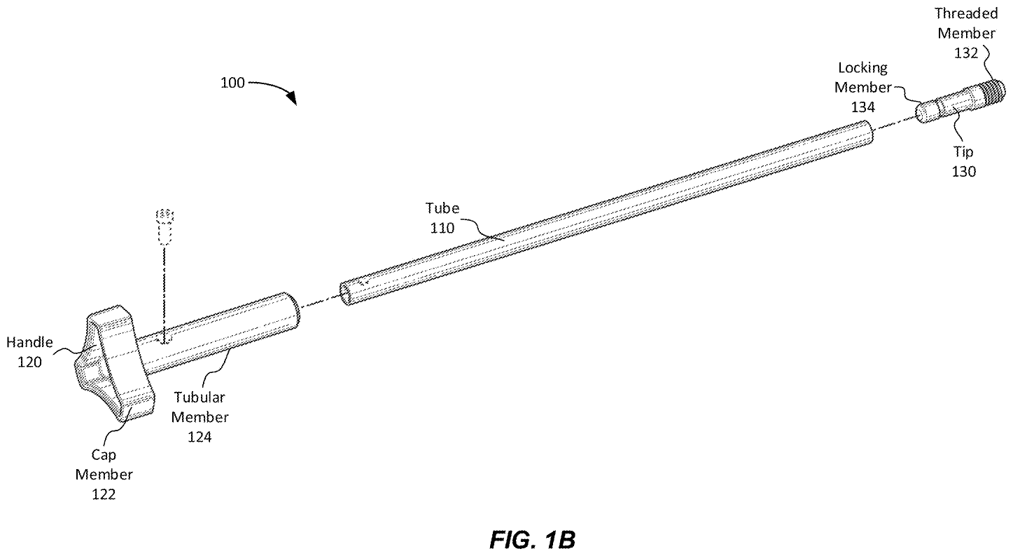

FIGS. 1A-1B illustrate a hanger assembly apparatus configured to connect a first component with a second component such that the second component is securely suspended beneath the first component with a sufficient physical gap. As illustrated in FIG. 1A, a hanger apparatus 100 includes a tube 110, a handle 120 and tip 130. In one example, the tube 110 is operably and releasably connected to each of the handle 120 and tip 130. When connected, the tube 110, handle 120, and tip 130 of hanger apparatus 100 move in unison, without any play. For example, when an operator uses holds the hanger apparatus 100 and twists the handle, the tip will also twist by the same mount.

In one example, as illustrated in FIG. 1A and further in FIG. 1B, the handle 120 of the hanger apparatus 100 can include a cap member 122 and tubular member 124. The tip 130 of the hanger apparatus 100 can include a threaded member 132 and locking member 134. In one example, the handle 120 is releasably connected to the tube 110 at the tubular member 124. The tubular member 124 of the handle 120 can be a hollow tubular member having a thickness such that an inner diameter of the tubular member, the hollow portion, has a diameter that is the same diameter as an outer diameter of the tuber. In this example, the tube 110 can securely fit into the tubular member 124 of the handle. In one example, the locking member 134 is releasably connected to the tube 110 at and end of the tube opposite that of the end of the tube connected to the tubular member 124. In this configuration, the tube 110 is hollow and receive the locking member 134. The outer diameter of locking member 134 can be substantially the same diameter as an inner diameter of the tube 110, the hollow portion of the tube 110, such that when the tip 130 is connected to the tube 110, the tip 130 is securely connected to the tube 110.

In one example, the tube 110 is an elongated rod that is hollow. The hollow rod allows for a lighter component compared to a same rod of the same material that is solid and does not have a hollow portion. In one example, the tube is comprised of carbon fiber. The carbon fiber can be 1K filament-12K filament carbon fiber. For example, the tube 110 can be made of 4K carbon fiber. The carbon fiber material minimizes weight from other materials and maximizes bending resistance during assembly such that any weight imbalance applied to the tube 110 will not bend the tube 110.

In one example, the handle 120 is comprised of aluminum. The cap member 122 and tubular member 124 can be a machined one-piece material or separate materials permanently secured to each other. In one example, the tip 130 is comprised of hardened steel. The threaded member 132 is threaded to an amount such than when used to mount and suspend a physical component beneath another physical component, such as a boom and a wing respectively, the tip 130 does not over tighten in the boom.

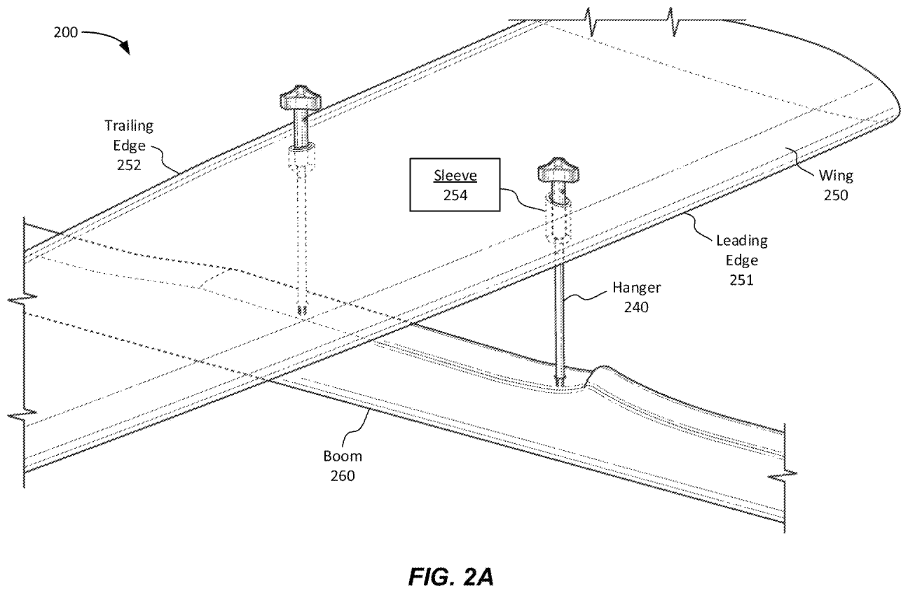

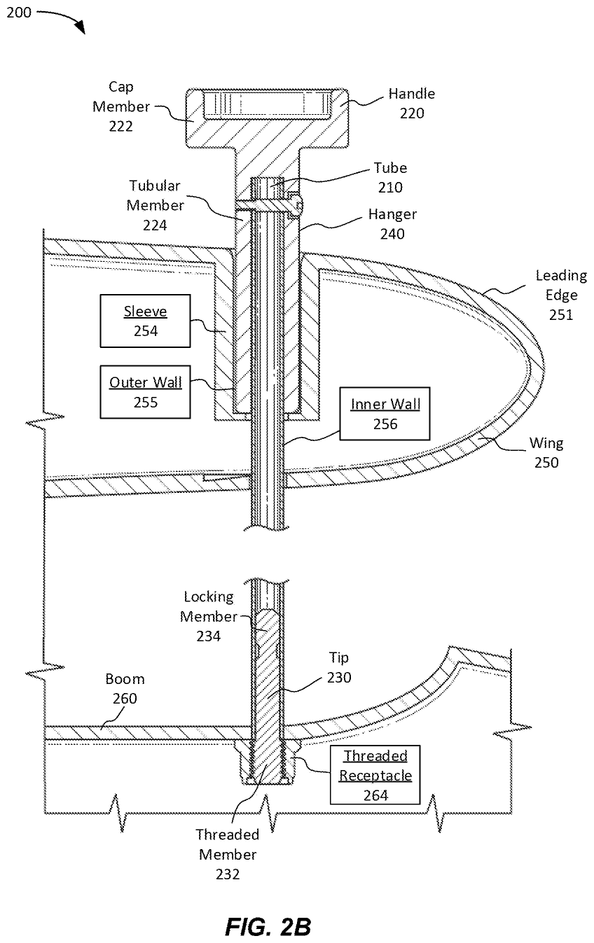

In one example, as illustrated in FIGS. 2A-2B, a hanger system is configured to allow one or more hangers to connect a first component such as a wing with a second component such as a boom of an aircraft, such that the second component is securely suspended beneath the first component with a sufficient physical gap. According to FIGS. 2A-2B, a hanger system 200 includes a hanger 240 operably connecting a wing 250 and boom 260. The wing 250 and boom 260 can be components of a vehicle such as an unmanned aerial vehicle (“UAV”).

In one example, the wing 250 of the unmanned aerial vehicle can span 1-3 meters in length. For example, the wing 250 can span 1.4 meters. The wing 250 can have a first side, center side, and second side of the wing 250 such that the first side of the wing 250 is the area of the wing 250 on the right-hand side of a fuselage or a body of the UAV and the second side of the wing 250 is the area of the wing 250 on the left-hand side of the body of the UAV. A first boom 260 can be configured to physically connect to the first side of the wing 250 and a second boom 260 can be configured to physically connect to the second side of the wing 250. In this configuration for example, each of the two booms 260 can each contain two vertically mounted propellers such that the fully assembled UAV will include at least a quadro-copter component to the UAV. In one example, the boom can have a length between 1-3 meters in length. For example, the boom 260 can span 1.5 meters. In one example, the wing 250 can have a first and second edge, such as leading edge 251 and trailing edge 252, each having a sleeve 254 such that a first hanger 240 can be received by the first sleeve 254 located near the leading edge 251 and a second hanger 240 can be received by a second sleeve 254 located near the trailing edge 252. In one example, each boom can be about 1 kg of weight but can vary depending on the configuration of the boom and the components associated with the boom such as electrical components, rotary components, or both.

In one example, the boom 260 is configured with a mounting hole located at a top surface of the boom. Each side of the wing 250 can have a leading edge 251 and trailing edge 252. The first side of the wing 250 can include a sleeve 254 that runs from a top surface of the wing 250 to a bottom surface of the wing 250 such that at least a portion of a first hanger 240 can be inserted through the top surface of the wing 250 and out of the bottom surface of the wing 250. For example, the hanger 240, comprised of a tube 210, handle, and tip 230 releasable connected to the tube at a locking member 234 of the tip 230, under operation is configured to be inserted into the sleeve 254 of the first side of the wing and mounted to the mounting hole of the boom in a first position. The mounting hole can be a threaded receptacle 264 configured to receive the threaded member 232 of the tip 230. In the first position, the handle of the hanger 240 is configured to rest on top of a portion of the sleeve and the tip 230 of the hanger 240 is configured to fasten onto the mounting hole of the boom. For example, the sleeve 254 that runs from the top surface of the wing 250 to the bottom surface of the wing 250 can include an outer wall 255 and inner wall 256 such that the outer wall has a larger wall than that of the inner wall 256. Accordingly, when the hanger 240 is inserted into the sleeve 254 of the wing 250, only the tip 230 and tube of the hanger 240 can pass through the inner wall 256. In one example, a diameter of the tube and threaded member 232 of the tip 230 is substantially the same diameter as that of the inner wall 256. The handle 220 includes a tubular member 224 and cap member 222. When the hanger 240 is operational, the tubular member 224 fits inside the outer wall 255 of sleeve 254. However, the tubular member is too large to fit or pass through the inner wall 256. Because the diameter of a first portion of the sleeve 254, such as the inner wall 256, is smaller than that of the diameter of the second portion of the sleeve 254, such as the outer wall 255 and the diameter of the tubular member 224, the handle 220 of the hanger 240 rests on top of the first portion of the sleeve. As such, when the hanger 240 is inserted through the wing 250 and mounted onto the boom, the hanger 240 is stopped from passing through all the way of the sleeve 254 and the boom is 260 is suspended beneath the first side of the wing 250 leaving a sufficient gap or distance between an underside or bottom side of the wing 250 and the top surface of the boom 260. In one example, the surface diameter of the tube 210 can be smaller than that of the diameter of inner wall 256. For example, 0.5 mm smaller. In this case, the surface diameter of the tubular member 224 of handle 220 can also be smaller than the diameter of outer wall 255, for example, by 0.5 mm. However, the tubular member 224 will still have a diameter bigger than that of the diameter of inner wall 256.

In one example, the hanger 240 is operational and is used to suspend the boom 260 underneath the wing 250, an operator does not need to hold the boom when working on other parts of the assembling process such as connecting wires that run from the top of the boom to connections or other components that run to the bottom of the wing. In one example, the gap that is left by the hanger when operably connecting the boom 260 and wing 250 in the first position can be about 2-10 inches running from the bottom surface of the wing 250 to the top surface of the boom 260. For example, the gap can be 2 inches or 4 inches. In one example, the gap can be predetermined by selecting a tube 210 that has a length such that when used in the hanger 240, the gap between the wing 250 and boom 260 is 4 inches. The longer the tube, the bigger the distance when the boom 260 is suspended beneath the wing 250.

In one example, the tip 230 can include a locking member 234 configured to releasably connect the tip 230 to the tube 210. The tip 230 can also include a hook member (not shown) instead of a threaded member, where instead of fastening to the boom 260, the hanger hooks the boom 260 to the hanger and suspends the hanger 260 beneath the wing 250 with a sufficient distance.

In one example, once the electrical connections are completed, or when an operator is ready to physically connect the boom 260 with the wing 250, the operator can physically lift the boom 260 to make contact with the wing 250. For example, the hanger 240 would be in a second position such that the underside or bottom surface of the wing 250 is mounted onto the top surface of the boom. At this second position, the operator can then remove the hanger from the boom 260 that is still inserted through the sleeve 254 by twisting the cap member 222 of the handle 220 and unfastening the threaded member 232 from the threaded receptacle 264. While holding the boom 260 in place underneath the wing 250, the same threaded receptacle 264 can be aligned with the sleeve 254 of the wing 250. In this position, a mounting fastener can be configured to securely mount the bottom side of the wing 250 to the boom 260, the mounting fastener mounting the first side of the wing to the boom through the sleeve 254 of the wing 250.

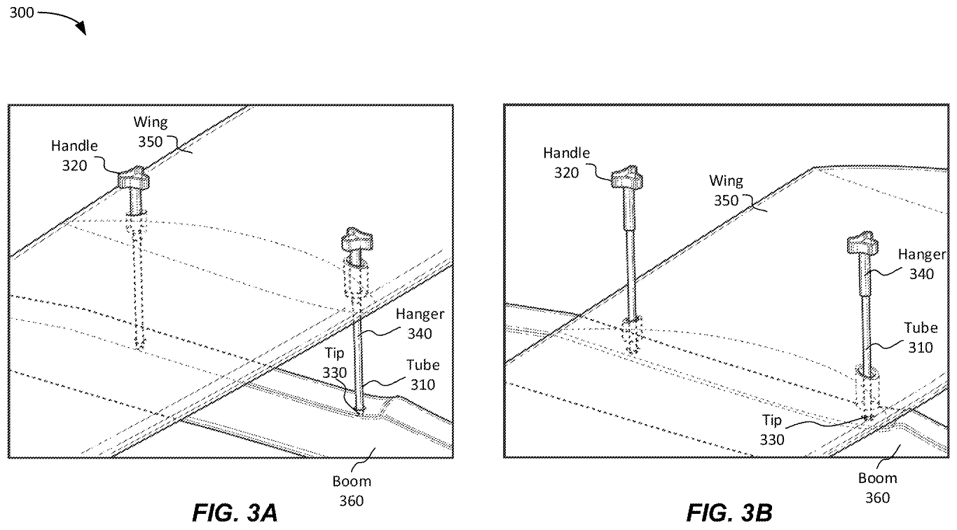

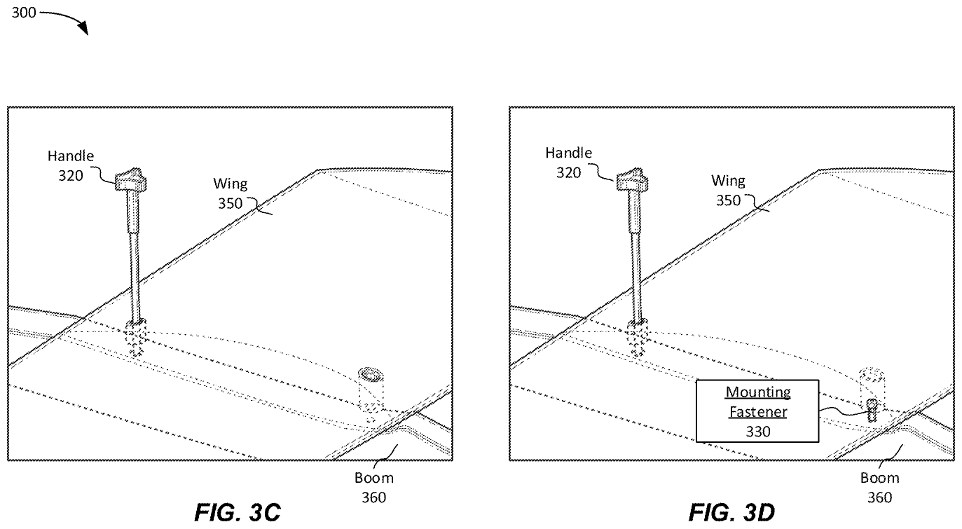

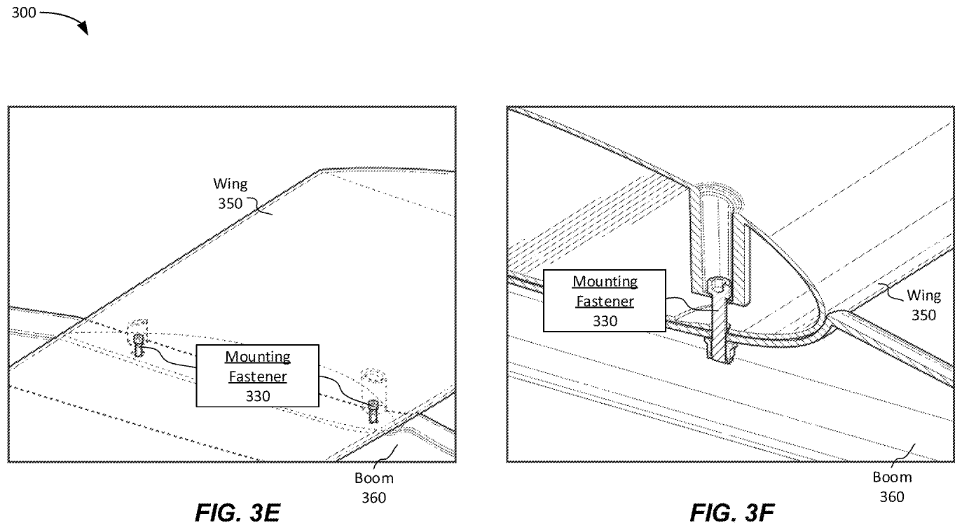

FIGS. 3A-3F illustrate different configurations of a hanger system for a UAV when in operation according to one example. As illustrated in FIG. 3A, a hanger system 300 includes a wing 350 and a boom 360. The wing 350 and boom 360 can be part of an aircraft such as a UAV. In this example, the wing 350 can have a first side and a second side such that each side is relative to a body portion of the UAV that bisects the two sides of the wing 350. The wing 350 can have a leading edge having a first sleeve near the leading edge of the first side of the wing and includes a trailing edge having a second sleeve near the trailing edge of the first side of the wing, wherein the first sleeve is configured to receive the first hanger 340 and the second sleeve is configured to receive a second hanger 340. For example, a pair of hangers 340, each having a tube 310, handle 320, and tip 330, are mounted onto a top surface of the boom 360 through the a pair of sleeves, one near the leading edge and another near the trailing edge of the wing, such that the boom 360 is secured in a fixed position beneath the wing where there is a sufficient distance between the boom 360 and wing 350.

In one example, the first tube 310 of the first hanger 340 at the leading edge of the wing 350 and rear tube are of different lengths such that when deployed and fastened to the boom 360 in the position suspended below the wing 350, the boom 360 can be parallel to the wing 350 about a horizontal axis. This is because the design of the wing 350 may not be uniform from the leading edge of the wing 350 to the trailing edge of the wing 350. If the handle 320 and tip 330 of the hanger 340 are the same, then in order for the orientation of the boom to be parallel to the wing under operation of the front and rear hangers 340, than the tubes 310 of the hangers 340 can be of different lengths, even when the tubes 310 are made of the same material and have the same circumference.

In one example, as illustrated in FIG. 3B, when the electrical cables, wiring, and electrical components are installed and connected between the boom and the wing or between the boom and any other component of the aircraft, the operator can lift the boom up to the wing such that the boom 360 makes contact with the wing 350 and is flush against the wing 350. In this configuration, the hangers 340 will still be in contact with the wing 350 and boom 360 as the threaded member of the hanger 340 will still be fastened to the boom 360.

In one example, as illustrated in FIG. 3C, the operator can remove one hanger 340 of multiple hangers. For example, in this configuration, there are two hangers 340 attached on one boom 360 along one side of the wing 350. The operator can twist the handle 320 of the hanger 340 to remove the hanger 340 while the other hand of the operator is continuing to keep the boom 360 flush against the wing 350.

In one example, as illustrated in FIG. 3D, the operator, while still holding boom with on hand, can mount a mounting fastener 330 into the same sleeve and threaded receptacle as that of the first hanger 340. Then mounting fastener would securely tighten and fix the boom 360 to the wing 350.

In one example, as illustrated in FIG. 3E, the operator can remove the second hanger 340 and install and mount the second mounting fastener 330 into the sleeve and threaded receptacle as that of the second hanger 340 near the trailing edge of the wing.

As illustrated in the FIG. 3F, the mounting fastener secures the wing 350 to the boom 360.

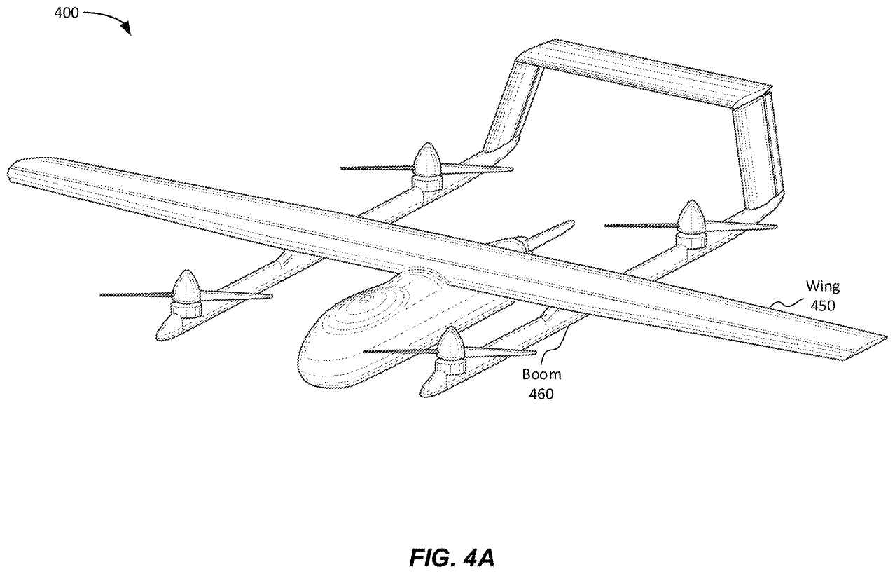

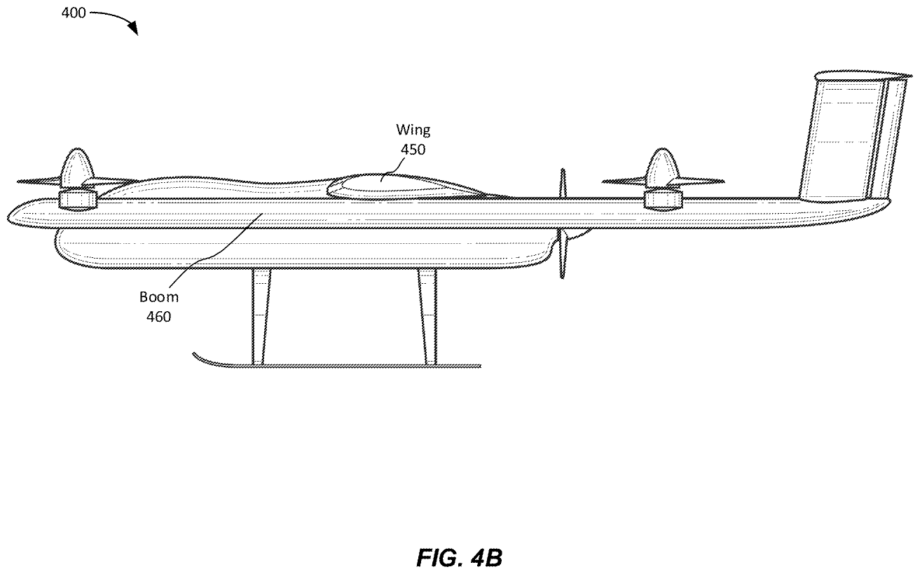

FIG. 4A-4B illustrates example embodiments of a drone. The drone depicted in FIGS. 4A-4B, such as drone 400, is configured to utilize boom hangers. In this example, the drone 400 can include a fuselage, a wing 450 that spans across the fuselage perpendicular to a length of the fuselage. Securely suspended beneath the wing 450 are a pair of booms 460. In this embodiment, each boom includes a pair of VTOL propellers. One boom 460 is configured to physically connect to a first side of the wing 450 and the second boom 460 is configured to physically connect to a second side of the wing 450. The booms 460 are also connected to each other through a tail wing at each of the rear portions of the booms 460. In this embodiment, the fuselage, wing 450, booms 460, and tail wing can be modular such that each component can be swapped out for a different unit of the same component. When fully assembled, as illustrated in FIGS. 4A-4B, the drone 400 can include five propellers, four vertically mounted propellers for VTOL and one horizontally mounted propeller for long range flight.

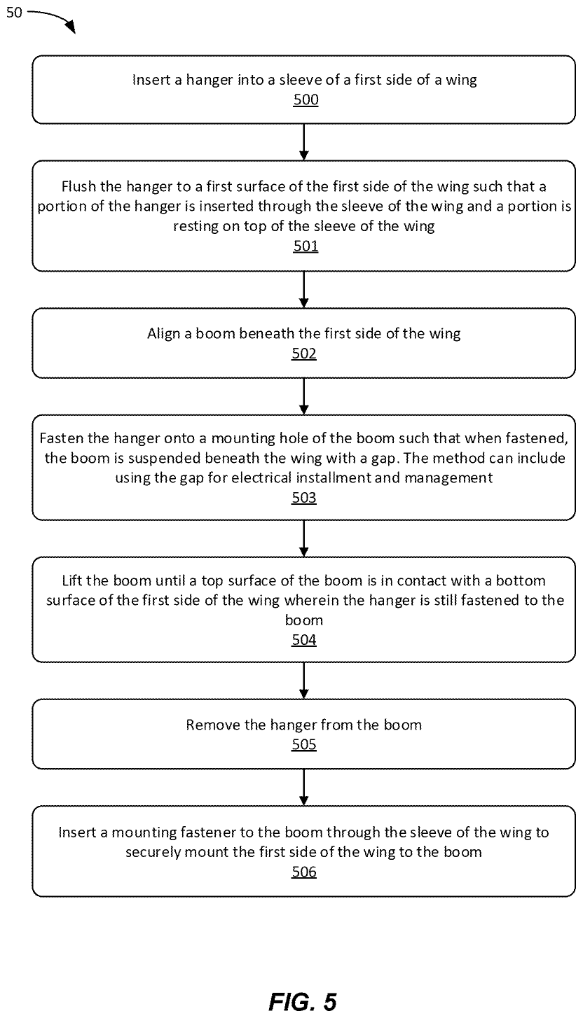

In one example, a method of assembling a portion of a drone in configurations similar to that of the hanger system described and illustrated in FIGS. 3A-3F is described below. FIG. 5 illustrates a flow chart for assembling a portion of a drone. In the example flow diagram 50, at block 500, the method can include inserting a hanger into a sleeve of a first side of a wing.

At block 501, the method can include flushing the hanger to a first surface of the first side of the wing such that a portion of the hanger is inserted through the sleeve of the wing and a portion is resting on top of the sleeve of the wing.

At block 502, the method can include aligning a boom beneath the first side of the wing.

At block 503, the method can include fastening the hanger onto a mounting hole of the boom such that when fastened, the boom is suspended beneath the wing with a gap. The method can include using the gap for electrical installment and management.

At block 504, the method can include lifting the boom until a top surface of the boom is in contact with a bottom surface of the first side of the wing wherein the hanger is still fastened to the boom.

At block 505, the method can include removing the hanger from the boom.

And at block 506, the method can include inserting a mounting fastener to the boom through the sleeve of the wing to securely mount the first side of the wing to the boom.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A boom assembly system, comprising:
a boom configured with a mounting hole located at a top surface of the boom;
a wing having a first side, the first side of the wing having a sleeve; and
a first hanger having a tube, handle, and tip, configured to be inserted into the sleeve of the first side of the wing and mounted to the mounting hole of the boom in a first position.

2. The boom assembly system of claim 1, wherein the handle of the hanger is configured to rest on top of a portion of the sleeve and the tip is configured to fasten onto mounting hole of the boom at the first position.

3. The boom assembly system of claim 2, wherein at the first position, the boom is suspended beneath the first side of the wing leaving a sufficient gap or distance between an underside of the first side of the wing and the top surface of the boom.

4. The boom assembly system of claim 1, further comprising the first hanger in a second position wherein an underside of the first side of the wing is mounted onto the top surface of the boom.

5. The boom assembly system of claim 4, further comprising a mounting fastener configured to securely mount the first side of the wing to the boom, the mounting fastener mounting the first side of the wing to the boom through the sleeve of the first side of the wing.

6. The boom assembly system of claim 1, wherein the vehicle is an aircraft.

7. The boom assembly system of claim 6, wherein the aircraft is an unmanned aircraft.

8. The boom assembly system of claim 1, wherein the sleeve of the first side of the wing runs from a top surface of the wing to a bottom surface of the wing.

9. The boom assembly system of claim 1, wherein the wing has a first and second edge having a first and second sleeve, respectively, wherein the second sleeve is configured to receive a second hanger.

10. The boom assembly system of claim 1, wherein the wing includes a leading edge having a first sleeve near the leading edge of the first side of the wing and includes a trailing edge having a second sleeve near the trailing edge of the first side of the wing, wherein the first sleeve is configured to receive the first hanger and the second sleeve is configured to receive a second hanger.

11. The boom assembly system of claim 10, wherein the first hanger and second hanger have different lengths.

12. The boom assembly system of claim 1, wherein a diameter of a first portion of the sleeve is smaller than that of the diameter of a second portion of the sleeve such that the handle of the first hanger rests on top of the first portion of the sleeve.

13. An apparatus, comprising:
a tube;
a handle having a cap member and a tubular member operably connected to a first side of the tube with the tubular member; and
a tip having a threaded member and locking member operably connected to a second side of the tube with the locking member of the tip.

14. The apparatus of claim 13, wherein the tube comprises a hollow elongated rod.

15. The apparatus of claim 13, wherein the tube is comprised of carbon fiber.

16. The apparatus of claim 13, wherein the handle is comprised of aluminum.

17. The apparatus of claim 13, wherein the thread is comprised of hardened steel.

18. The apparatus of claim 13, wherein the tubular member of the handle is a hollow tubular member with a thickness such that an inner diameter of the hollow tubular member is the same diameter as that of an outer diameter of the tube.

19. A method of assembling a portion of a drone, the method comprising:
inserting a hanger into a sleeve of a first side of a wing;
flushing the hanger to a first surface of the first side of the wing such that a portion of the hanger is inserted through the sleeve of the wing and a portion is resting on top of the sleeve of the wing;
aligning a boom beneath the first side of the wing;
fastening the hanger onto a mounting hole of the boom such that when fastened, the boom is suspended beneath the wing with a gap;
lifting the boom until a top surface of the boom is in contact with a bottom surface of the first side of the wing wherein the hanger is still fastened to the boom;
removing the hanger from the boom; and
inserting a mounting fastener to the boom through the sleeve of the wing to securely mount the first side of the wing to the boom.

20. The method of claim 19, further comprising using the gap for electrical installment and management.
